(19) United States
(12) Patent Application Publication
(10) Pub. No.: US 2008/0059192 A1
(43) Pub. Date: Mar. 6, 2008

(54) Method and System for Performing Telecommunication of Data

(76) Inventors: Marian Trinkel, Kreuzau (DE); Frank Daussmann, Hassloch (DE)

Correspondence Address: GUDRUN E. HUCKETT DRAUDT, SCHUBERTSTR. 15A, WUPPERTAL, 42289, DE

(21) Appl. No.: 11/622,001

(22) Filed: Jan. 11, 2007

(30) Foreign Application Priority Data
Jan. 13, 2006 (DE) 10 2006 002 604.7

(51) Int. Cl. G10L 13/08

(52) U.S. Cl. 704/260

(57) ABSTRACT

In a method for performing telecommunication of data through a telecommunication network, at least one telecommunication data set is transferred and the at least one telecommunication data set is examined in regard to whether speech-representing data are contained. The at least one telecommunication data set is preferably examined with regard to a parameter that indicates speech or with regard to portions that are representative for speech.

### BACKGROUND OF THE INVENTION

The invention relates to a method and a system for performing telecommunication of data by means of a telecommunication network, in particular the Internet, wherein at least one telecommunication data set is transferred.

It is well known in the prior art to carry out voice telecommunication, for example, in the form of a conventional telephone call through the telephone network. In this connection, it is known to measure the duration of such a telephone call in order to subsequently bill for the telephone call, based on the duration and based on an appropriate fee per time unit.

By utilizing the Internet as well as optionally other telecommunication networks, the possibility of data telecommunication has been established in the meantime; through such telecommunication networks a call between two persons by means of data telecommunication can be realized, for example, by the principle of voice over internet protocol (voice over IP or VOIP). In this connection, data corresponding to the spoken communication of the persons are usually generated by means of a computer so that the data representing the spoken words (voice) are transferred.

Since usually the utilization of data telecommunication, for example, within the context of the Internet, is less expensive than voice communication of the conventional kind, telephony via the Internet or other telecommunication networks is becoming more and more popular. This leads to a significant drop in earnings for the telecommunication companies.

In the U.S.A., a tax on voice contents is levied for telephony; thus, tax revenue will drop when using voice over IP or any other type of telephone communication by means of data communication.

Moreover, it is known that telecommunication traffic, in particular, voice telephony, at least when certain conditions are met, can be legally wiretapped by government agencies. Monitoring such voice telephony however is difficult or even impossible when done by data telecommunication. Wiretapping a telephone call is therefore made significantly more difficult for government agencies.

### SUMMARY OF THE INVENTION

It is an object of the present invention to provide a method for performing data telecommunication with which the aforementioned disadvantages are overcome, which thus provides in particular the possibility of enabling different types of billing methods for voice contents (spoken word contents) and a targeted observation of voice telephony even if carried out by means of data telecommunication.

According to the method of the present invention and according to the system of the present invention, this is object is solved in that at least one telecommunication data set is checked to see whether it contains data representing voice or spoken word.

One or several telecommunication data sets are generated and transferred in the context of voice telecommunication as well as in the context of data telecommunication, i.e., they pass in particular through an exchange. Such a telecommunication data set conventionally comprises, aside from the user data to be transferred, also additional parameters, for example, a telecommunication access identifier of the sending telecommunication device as well as a corresponding identifier of the receiving telecommunication device and optionally furthermore information in regard to time, data volume etc.

Moreover, there is the possibility that a telecommunication data set comprises a parameter that indicates whether voice-representing data are being sent by means of this telecommunication data set.

By checking at least one telecommunication data set—optionally and especially preferred all telecommunication data sets that are created and transferred during a data telecommunication are checked—it is therefore possible to check whether a telecommunication data set contains data that represent voice. Based on this information, such a data set can then be subjected to a further examination and/or evaluation or similar processes, for example, for monitoring or evaluation purposes.

According to one embodiment of the method, it can be provided that a telecommunication data set is examined with regard to a parameter representing voice. Inasmuch as a telecommunication data set is provided with such an indicator parameter that indicates, for example, whether the user data of the telecommunication data set are regular data or voice data, it is possible to carry out a check in an especially simple way because in this case only the indicator parameter must be queried and evaluated.

Since it is conceivable and possible that not all transfer protocols for the data telecommunication are provided with such a parameter for identifying or indicating voice data or since there may be the possibility that a third party may manipulate such a parameter, in accordance with an especially preferred embodiment of the method according to the invention it is provided, alternatively or cumulatively relative to the aforementioned aspect, that the user data of a telecommunication data set are examined with regard to portions that represent voice or speech.

For example, this can be done by means of a special method and/or a device for speech recognition, wherein the entire data quantity or only the user data of the telecommunication data set is subjected to the speech recognition method and/or passed through the speech recognition device. For example, an appropriate speech recognition program can run e.g. on a computer that is part of a communication network. For example, a corresponding implementation can be realized in an exchange of the telecommunication network.

Thus, each generated and transferred telecommunication data set would pass through such a speech recognition device or would be subjected to such a speech recognition method in order to be subjected to evaluation and examination. The same or a similar implementation can also be realized when, as mentioned above, a telecommunication data set is marked by means of a parameter that represents voice or speech.

In particular in the case of implementing speech recognition for examining the data, in particular, the user data, it can be provided that the data are compared with at least one comparison pattern that is conventional for or common to speech wherein, in the case of at least a partial match, it can be deduced that speech is present within the user data.

This method is based on the knowledge that speech or voice data usually contain certain data patterns that can be detected within the user data. This is so primarily because the conversion of speech into data, which is initially the basis for a data telecommunication for transferring speech, is done based on certain criteria and method steps that are characteristic so that in this way user data that contain speech or voice data can be differentiated from other data.

In particular, this can be so because, when converting speech into data, spoken words of a person are divided, for example, into units such as words, word fragments, letters, phonemes etc. so that such patterns, for example, the words, word fragments, letters, phonemes etc. are typical and recurring within the data that represent speech. Accordingly, an examination of the user data of a telecommunication data set with regard to the presence of such patterns can be performed.

It can also be provided that the data to be examined are converted into acoustic data, in particular into audible information, before being examined. After such a conversion, a comparison with an acoustic comparison pattern can be performed, for example, by means of an acoustic pattern detector that can also be realized by software.

This, when such typical patterns (data patterns, acoustic patterns)—optionally saved as comparative patterns—are found in the data, in particular in the user data, it is possible to deduce for an at least partial match that speech is present at least partially.

In regard to the present invention, it has been found to be particularly advantageous that it is not mandatory for the user data and the other data of a telecommunication data to be separated before comparing them to saved comparative patterns. If somewhere within the data of a telecommunication data set a pattern that corresponds or is similar to the comparative pattern is present, this will be detected.

In accordance with one embodiment of the invention, it is possible that monitoring of data representing speech can be performed by means of any speech recognition software. In this connection, it does not matter which vocabulary has been used for training the speech recognition program for performing the check. For example, a speech recognition program that has been trained for recognizing a foreign language can be used relative to the speech data that are actually present at the time of monitoring. This does not allow for recognizing the meaning of the checked data but it can be determined whether data representing speech of any language are present or not.

According to a further embodiment of the method it can be provided that after detection of speech or at least portions of speech in the user data, the user data and/or the entire telecommunication data set can be parametrized. Such a parametrization can be done in that, for example, an identifier that indicates speech or voice contents is attached to the user data or to the telecommunication data set.

Such monitoring and adding of an identifier can be done, for example, by a checking unit that is implemented in the telecommunication network, for example, within an exchange.

In this connection it can be provided, for example, that such an identifier that has been added to the user data or a telecommunication data set represents the probability of finding voice contents within a telecommunication data set. For example, a greater or lesser degree of concordance of the user data with comparative data or comparative patterns can be present so that the degree of concordance does not safely indicate voice contents but only indicates a probability of the presence of voice contents. For example, it can be expedient in regard to further processing of the information relating to speech contents being present at a certain probability to additionally utilize precisely said probability.

In particular for the aforementioned purposes of billing or also of monitoring or surveillance of data representing speech, it can be in particular provided that the telecommunication data sets and/or user data that represent at least partially voice or speech data are registered and/or counted.

This enables on one hand after the registration—meaning in particular detecting and saving—retrieval of the transferred speech information in order to evaluate it.

It can also be provided that, based on the registered and/or counted telecommunication data sets and/or user data, an equivalent time period is deduced corresponding to a voice telecommunication done conventionally by telephone for the same contents. The detected equivalent time period can be used, for example, in order to enable billing for the telephone call that has been done by means of data telecommunication, for example, based on a certain billing unit based on time. Also, it is possible to use for billing across-the-board the detected duration of the connection provided between two telecommunication devices, in particular when voice data have been found in the telecommunication data sets during the duration of the connection.

### BRIEF DESCRIPTION OF THE DRAWING

FIG. 1 is a schematic representing a method according to the invention.

FIG. 2 is a schematic representing a system according to the invention.

FIGS. 3a and 3b illustrate an acoustic comparison.

### DESCRIPTION OF THE PREFERRED EMBODIMENTS

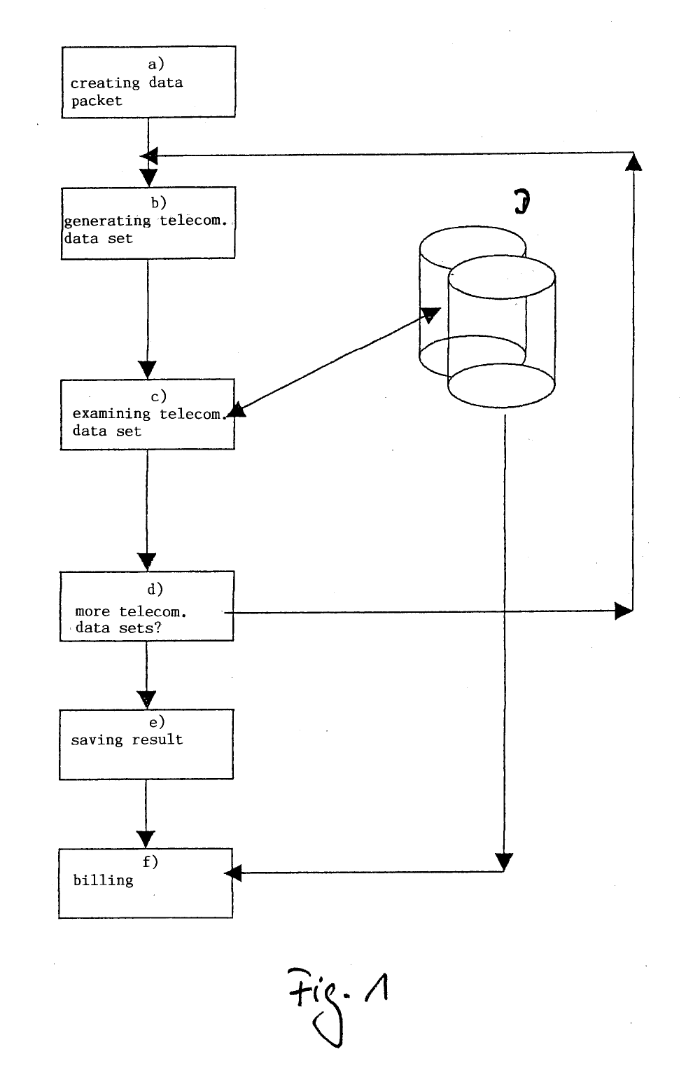

FIG. 1 illustrates that in step a) a data packet is created, for example, when a user performs Internet telephony. This data packet represents thus voice data or speech data. Upon transfer of the data packet, a telecommunication data set is created internally within the telecommunication data network by means of an appropriate system, for example, in order to enable billing (step b)).

Such a telecommunication data set can contain, in addition to the user data, information in regard to the sender, receiver, type of device etc., for example in the form of so-called headers and trailers. For example, the information can be the IP address of the sender or of the receiver.

The telecommunication data set which is produced in step b) can be examined in step c) in detail, for example, by means of a checking unit provided for this purpose. The checking unit examines the telecommunication data set in regard to a parameter that identifies speech or, inasmuch as such a parameter is not present, the user data themselves are examined with regard to the presence of at least one pattern that is common to or representative for speech based on a comparison with at least one comparative pattern; for this purpose, the data base D is used in which comparative patterns are saved.

When speech data have been found, the telecommunication data set, or optionally only the user data in the telecommunication data set, can be provided with an identifier. There is then the possibility of saving or evaluating the date for billing purposes, for example, in the databases D. In step d) it is then checked whether additional telecommunication data sets are present or follow during the ongoing telecommunication. Should this be the case, the examination of the telecommunication data set according to the afore described steps is repeated.

Should there be no further telecommunication data sets, the telecommunication is terminated so that in step e) the examination result can be saved; in particular, all telecommunication data sets or user data that have been provided with an appropriate identifier, optionally also all telecommunication data sets or user data that have been transferred during telecommunication, are saved so that there is the possibility of generating a bill at least based on the marked (i.e., identifier attached) user data or telecommunication data sets in step f). For this purpose, these marked telecommunication data sets can also be transferred from the databases D.

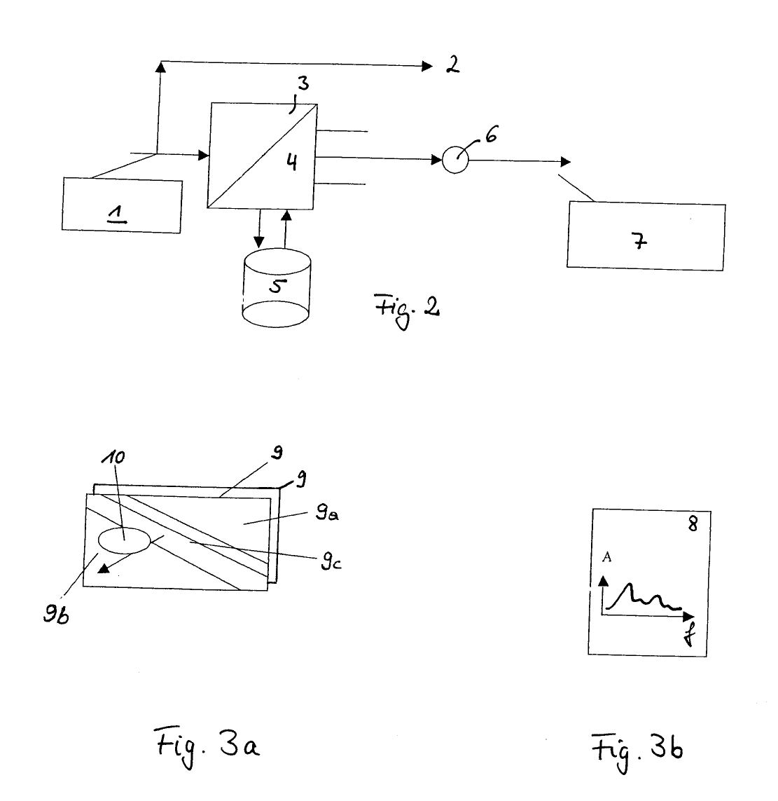

FIG. 2 shows furthermore schematically that the total data 1 of one or several telecommunication data sets on their path to a receiver 2 can be supplied to a transducer 3, for example, through a branch. The transducer 3 converts the data into acoustic data or signals. Such a transducer 3 can be realized within a speech recognition means 4; for example, the transducer 3 and the speech recognition means 4 can be combined to form a unit.

The total data 1 or a portion of the data are compared within the speech recognition means 4 with at least one comparative pattern, in this case an acoustic comparative pattern that is saved in a database 5.

When the comparison provides a positive result or when the probability of the presence of speech-representing data is greater than a predetermined or preset threshold, a trigger 6 can be set, for example, 1 for recognized speech or 0 when no speech is recognized.

The thus obtained result, for example, the trigger 6, can be supplied to further processing means 7, for example, for evaluation or billing.

FIG. 3a illustrates schematically the possibility of performing an acoustic comparison.

The data derived from the total data stream or a temporally limited portion of data of the total data stream of a communication, for example, the data of one or several telecommunication data sets, optionally only the user data, are converted to acoustic data or signals, for example, in that the binary data pass through a loudspeaker. Optionally, this conversion can be omitted and the electronic data or the converted data can be subjected to examination with regard to amplitude and frequency, for example, by Fourier transformation 8 (FIG. 3b). The result of the transformation can be compared to an acoustic comparative pattern.

The result 10 of the comparison can be identified in a result space 9 in accordance with the probability that has been determined. In this connection, the position of the result 10 in the result space 9 illustrates the probability at which speech or voice has been detected. The result space 9 is divided into different areas, for example an area 9a that represents only regular data (no speech or voice data); an area 9b that represents only speech; and an intermediate area 9c.

By means of several iterative comparisons, the result 10 becomes more and more precise and moves into the respective result space 9a, 9b, or 9c; for example, in the direction “speech” (area 9a). Based on this result, markings (for example, trigger) can be set in order to indicate that speech is contained in the data.

The specification incorporates by reference the entire disclosure of German priority document 10 2006 002 604.7 having a filing date of Jan. 13, 2006.

While specific embodiments of the invention have been shown and described in detail to illustrate the inventive principles, it will be understood that the invention may be embodied otherwise without departing from such principles.

What is claimed is:

1. A method for performing a telecommunication of data through a telecommunication network, the method comprising the steps of:
transferring at least one telecommunication data set;
examining the at least one telecommunication data set in regard to whether speech-representing data are contained.

2. The method according to claim 1, wherein the at least one telecommunication data set is examined with regard to a parameter that indicates speech.

3. The method according to claim 1, wherein data of the at least one telecommunication data set are examined with regard to portions that are representative for speech.

4. The method according to claim 3, wherein said data of the at least one telecommunication data set are user date of the at least one telecommunication dada set.

5. The method according to claim 3, wherein said data of the at least one telecommunication data set are examined by a speech recognition means.

6. The method according to claim 5, further comprising the step of comparing said data of the at least one telecommunication data set with at least one comparative pattern representative for speech, wherein for an at least partial match between said data of the at least one telecommunication data set and said comparative pattern the presence of said speech-representing data is deduced.

7. The method according to claim 6,wherein said data of the at least one telecommunication data set are user data.

8. The method according to claim 6, wherein said data of the telecommunication data set are binary data, wherein the method further comprises the step of converting said binary data into acoustic data before the step of comparing and the step of supplying the acoustic signals to an acoustic pattern detector in which acoustic pattern detector the step of comparing is carried out by comparing the acoustic data with at least one acoustic comparison pattern.

9. The method according to claim 8, wherein said data of the at least one telecommunication data set are user data.

10. The method according to claim 6, further comprising the step of parametrizing said data of the at least one telecommunication data set when the presence of speech-representing data is deduced.

11. The method according to claim 10, wherein in the step of parametrizing an identifier is attached that indicates speech contents.

12. The method according to claim 10, wherein the identifier represents a probability of the speech contents in said data of the telecommunication data set.

13. The method according to claim 1, wherein the at least one telecommunication data set or user data of the at least one telecommunication data set that contain at least partially speech contents are registered and/or counted.

14. The method according to claim 13, further comprising the step of deducing, based on the at least one telecommunication data set or the user data that are registered and/or counted, an equivalent time period of a telephonic speech communication.

15. The method according to claim 14, wherein the equivalent time period is used for billing.

16. A system for performing a data telecommunication through a telecommunication network by transferring at least one telecommunication data set, the system comprising a checking unit that examines the at least one telecommunication data set in regard to whether speech-representing data are contained in the at least one telecommunication data set.
